(19) United States
(12) Patent Application Publication
(10) Pub. No.: US 2014/0215511 A1
(43) Pub. Date: Jul. 31, 2014

(54) TELEVISION INTERACTIVE SYSTEM

(71) Applicant: CHI-TAI LIN, Taipei City (TW)

(72) Inventor: CHI-TAI LIN, Taipei City (TW)

(21) Appl. No.: 14/159,477

(22) Filed: Jan. 21, 2014

(30) Foreign Application Priority Data
Jan. 31, 2013 (TW) 102103815

(51) Int. Cl. H04N 21/431; H04N 21/81; H04N 21/422; H04N 21/231; H04N 21/41; H04N 21/234; H04N 21/482

(52) U.S. Cl. CPC H04N 21/431; H04N 21/23424; H04N 21/812; H04N 21/4821; H04N 21/23109; H04N 21/4126; H04N 21/422
USPC 725/32

(57) ABSTRACT

The present invention discloses a television interactive system provided for at least one audience. The television interactive system includes a program display device, a channel selection module, an interactive operation module and an interactive display device. The program display device receives and displays an audio/video program and/or an advertisement from a host device of a system supplier. The channel selection module is provided for the corresponding audience to control the selected audio/video program displayed by the program display device. The interactive operation module receives and displays the interactive message, and enables the audience to perform an interactive operation based on the interactive message so as to generate a response message transmitted to an interactive message server processing the interactive operation on the programs or advertisements, thereby implementing an interactive function.

### CROSS-REFERENCE TO RELATED APPLICATION

This application claims the priority of Taiwanese patent application No. 102103815, filed on Jan. 31, 2013, which is incorporated herewith by reference.

### BACKGROUND OF THE INVENTION

1. Field of the Invention

The present invention generally relates to a television interactive system, and more specifically to a television interactive system providing an interactive operation module to implement the interactive function for the audience and the programs/advertisements.

2. The Prior Arts

Since the first black and white television set came on the market at the last century, various advanced television sets have been developed by use of new technologies and thus become one of the most popular and widely used electronic devices, providing amusements, news, advertisement information by traditional one-way broadcasting scheme. As the progress of the broadcasting technologies and the increasing population of the communication network, the television industries have gradually utilized the interactive television sets with bi-directional broadcast to implement the interactive function among the audiences, the advertising companies and the programs. For example, the audiences are allowed to vote on-line in the television-elected show so as to immediately determine the winner from all the competitors. Alternatively, the advertising agencies may provide free samples or coupons in the advertisement of new products for the on-line audiences, each issuing an appropriate request.

In the current application of the interactive television sets, however, the interactive function provided for the audiences is often implemented by showing the program contents or advertisements in the television set at the same time through scrolling text marquee, multiple division frames or overlap frames. As a result, the integrity of the program and the anticipated effect of entertainment are seriously deteriorated.

Additionally, if several audiences share the television set in a watch space such a living room, one of the audiences performing the interactive operation may interfere with the others. Also, another audience fails to individually perform the interactive operation at the same time because the interactive message is displayed and processed by the same television set.

Therefore, it is greatly desired to provide a television interactive system having an interactive display device individually operated without any influence on the integrity of the program frame so as to implement the interactive function for the audiences. For the watch space with more than one audience to share the same television set, if one audience is performing the interactive operation, other audiences are not influenced and can perform interactive operation at the same time, thereby overcoming the problems of the prior arts.

### SUMMARY OF THE INVENTION

The primary objective of the present invention is to provide a television interactive system comprising a program display device, a channel selection module, an interactive operation module and an interactive display device. Specifically, the channel selection module is connected to the program display device and the interactive operation module for providing an interactive function between the programs/advertisements and the audience. The program display device receives and displays the audio/video programs/advertisements from a host device of a system supplier. The channel selection module is provided for a corresponding television audience to select a program channel and generate a channel selection control message transmitted to the program display device through a wire or wireless means so as to control the program display device to display the corresponding audio/video programs. The channel selection module integrates an identification data associated with the audio/video program into a receive audio/video message, and at the same time, an interactive message corresponding to the receive audio/video message is fetched from an interactive message database and transmitted to the interactive operation module, which is used to control the interactive display device to display the interactive message. The audience thus performs an interactive operation based on the interactive message to generate a response message transmitted through a communication network to an interactive message server, which processes the interactive programs/advertisements.

Therefore, the audience may take advantage of the channel selection module to select the channel program to be displayed, and further control the interactive display device to display the interactive message by use of the interactive operation module. At the same time, the interactive operation module is employed to generate a response message, which is transmitted to the interactive message server for the interactive programs/advertisements, thereby implementing the interactive function. In particular, the normal channel programs are displayed as usual without any influence or interference.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing a television interactive system according to the first embodiment of the present invention;

FIG. 2 is a view showing a television interactive system according to the second embodiment of the present invention;

FIG. 3 is a view showing a television interactive system according to the third embodiment of the present invention; and

FIG. 4 is a view showing a television interactive system according to the fourth embodiment of the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

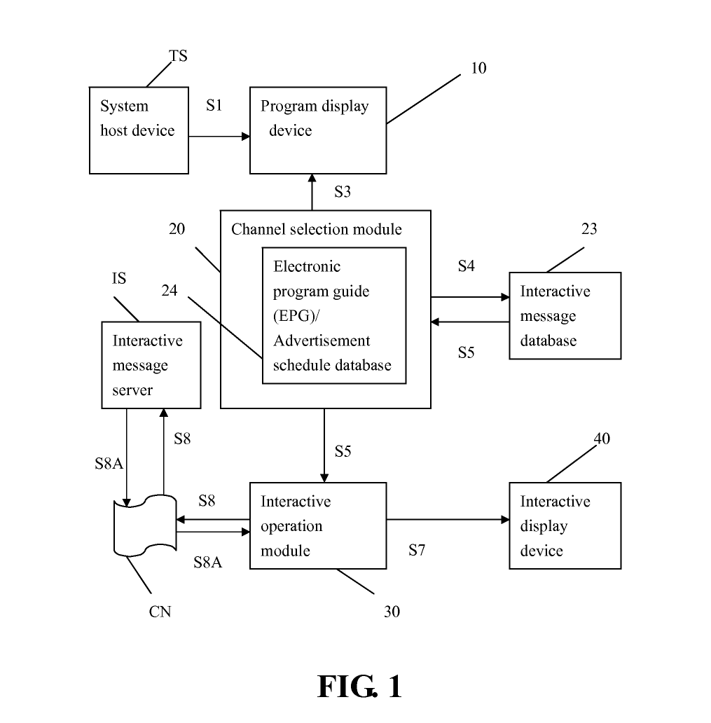

Please refer to FIG. 1 for showing the television interactive system according to the first embodiment of the present invention. As shown in FIG. 1, the television interactive system of the first embodiment generally comprises a program display device 10, a channel selection module 20, an interactive operation module 30 and an interactive display device 40, for providing an interactive function between the programs/advertisements and the audiences watching television.

Specifically, the program display device 10 receives the audio/video information S1 from the host device TS of the system supplier, and the audio/video information S1 at least comprises the audio/video programs and the advertisement contents, which are displayed by the program display device 10. Some illustrative examples of the program display device 10 are television sets, set top boxes, monitors with the image display function, computer monitors or the projectors. The host device TS may comprise the system host device used to service cable TVs, wireless TVs or web TVs.

The channel selection module 20 has an operation interface (not shown) of channel switch or program selection, which is provided for the audience to switch the channel of the audio/video program or program on demand displayed in the program display device 10. In other words, the audience is allowed to switch the program channel or select program on demand to generate the channel selection control message S3 transmitted to the program display device 10 through the wire or wireless means so as to control the corresponding audio/video programs displayed on the program display device 10. The above means for transmitting the channel selection control message S3 may comprise Infrared (IR), Bluetooth, WiFi or internet.

Additionally, the channel selection module 20 integrates the identification (ID) data associated with the audio/video program into the receive audio/video message S4, then fetches the interactive message S5 from the interactive message database 23 based on the receive audio/video message S4, and passes the interactive message S5 to the interactive operation module 30. Specifically, the receive audio/video message S4 at least comprises the channel ID code and the present time for the audio/video program being displayed. If the electronic program guide (EPG)/advertisement schedule database 24, or called the EPG 24 for short, is included in the channel selection module 20, the program code and the advertisement code can be fetched from the EPG 24 based on the channel ID code and the present time, or in case of program on demand, the channel ID code and present time are directly assigned as the program code and the advertisement code, respectively. Further, the channel ID code may correspond to the channel ID data based on the channel number through the host device TS. The interactive message S5 includes a descriptive text, video, webpage or web address, and so on. The interactive message database 23 stores a plurality of interactive messages S5, each corresponding to one receive audio/video message S4. Without the EPG 24, the channel selection modul2 20 fetches the corresponding interactive messages S5 from the interactive message database 23 based on the channel ID code and the present time included in the receive audio/video message S4. In case of the EPG 24 included in the channel selection module 20 or program on demand, the corresponding interactive messages S5 is directly fetched from the interactive message database 23 based on the program code and the advertisement code. Preferably, the interactive message database 23 is configured in a proximal or remote server or the EPG 24. That is, the interactive message database 23 can be included in the EPG 24 to simplify the overall system architecture.

The interactive messages S5 is fetched from the interactive message database 23 by the channel selection module 20, or alternatively, the channel selection module 20 may directly transmits the receive audio/video message S4 to the interactive operation module 30 such that the interactive operation module 30 fetches the interactive messages S5 from the interactive message database 23 and transmits it.

The operation interface of channel switch and program on demand may comprise a plurality of control keys for specific preset functions, such as numeric keys, letter keys, symbol keys, function keys and power keys. Additionally, the operation interface can be implemented by the touch screen, which provides the touch control function displaying a plurality of control icons like numeric keys, letter keys, sign keys, function keys and power keys for the audience to select the desired icon by clicking/touching/pressing so as to switch the channel.

The interactive operation module 30 is used to receive or directly fetch the interactive messages S5 to generate and transmit the corresponding display message S7 to the interactive display device 40, which displays the received display message S7. At the same time, the interactive operation module 30 possesses an interactive operation interface (not shown) for providing the audience to perform the interactive operation according to the display message S7 displayed on the interactive display device 40. As a result, the response message S8 is generated and then transmitted through the communication network CN to the interactive message server IS, which provides and transmits the further interactive message SA8 to the interactive display device 40 through the communication network CN so as to show the further interactive message SA8 for the audience, thereby achieving the bi-directional interactive function. Furthermore, the communication network CN may comprise a wire or wireless network.

The above interactive messages S5 may further contain an interactive processing period of time such that the interactive operation module 30 transmits the display message S7 to the interactive display device 40 after the interactive processing period of time, and then the interactive operation starts.

The interactive operation interface preferably has a plurality of control keys such as numeric keys, letter keys, symbol keys, function keys and power keys, or the interactive operation interface can be implemented by the touch screen. Moreover, it is preferred that the interactive operation module 30 and the interactive display device 40 are combined together, or alternatively the channel selection module 20, the interactive operation module 30 and the interactive display device 40 are integrated as a body for the sake of convenience. For example, the smart phone or tablet PC with APP (application) software is suitable to implement the functions of the interactive operation module 30 and the interactive display device 40, or the functions of the channel selection module 20, the interactive operation module 30 and the interactive display device 40.

Therefore, the audience manipulates the channel selection module 20 of the television interactive system of the present invention to select the content of the desired channel program, and then controls the interactive display device 40 through the interactive operation module 30 to display the display message S7 corresponding to the interactive message S5. At the same time, the interactive operation module 30 generates and transmits the response message S8 to the interactive message server IS so as to achieve the interactive function. In particular, the display message S7 is displayed by the discrete interactive display device 40 such that the integrity of the original display frame shown by the program display device 10 is kept with no change. For the other audiences who share the same program display device 10 to watch the audio/video program and advertisements can still enjoy the normal content of the channel program without feeling any interference or negative influence.

To further explain the aspects of the present invention, some illustrative examples are described in more detail hereinafter.

Part of the content of the interactive message database 23 is shown below:

| | Channel | | Program/Adver- |
|---|---|---|---|
| Interactive message | ID code | Show time | tisement code |
| “please select the number of the | TTV | 102/01/01 | P01-102002 |
| candidate for the champion” | | 20:00 | (super idol-160) |
| “welcome to request of the free | CTV | 102/01/01 | A02-102001 |
| sample of moistening facial | | 22:10 | (try out the |
| film, and please leave mail | | | moistening |
| address to deliver” | | | facial film) |

Part of the content of the channel ID code database is shown as follows:

| Host device of the | Channel | Channel |
|---|---|---|
| system supplier | number | ID code |
| Grand Taipei Cable TV | CH10 | FTV |
| Grand Taipei Cable TV | CH12 | TTV |
| Grand Taipei Cable TV | CH14 | CTV |

Part of the content of the EPG 24 in Grand Taipei Cable TV is shown as follows:

| Channel | | | |
|---|---|---|---|
| ID code | Show time | Program name | Program code |
| TTV | 102/01/01 | TTV night news | P01-102001 |
| | 19:00 | | |
| TTV | 102/01/01 | Super idol-160 | P01-102002 |
| | 20:00 | | |

For the program of the channel 12 selected by the audience, if the program display device 10 is a television set, an universal infrared remote control module can be used as the channel selection module 20, and the selection channel control message S3 is the infrared remote control signal for selecting the channel CH12 so as to control the program display device 10 to switch to the 12th channel. The channel selection module 20 integrates the ID information related to CH12 into the receive audio/video message S4, and the channel ID code for the receive audio/video message S4 is found from the channel ID database, being TTV (Taiwan TV). If the present time is 102/01/01 20:00, the channel ID and the present time can also be used to find the program code from the EPG database 24, being P01-102002. At this time, the interactive message S5 corresponding to the channel ID code “TTV” and the present time “102/01/01 20:00” is fetched from the interactive message database 23, being “please select the number of the candidate for the champion”. Alternatively, the corresponding interactive message S5 found from the interactive message database 23 by use of the program code “P01-102002” is also “please select the number of the candidate for the champion”. The interactive message S5 is further transmitted to the interactive operation module 30.

The interactive operation module 30 receives the interactive message S5 and then generates the corresponding display message S7 “please select the number of the candidate for the champion”, which is transmitted to the interactive display device 40 to show, such that the audience can start performing the interactive operation. The above description is only intended for illustrative examples.

In summary, the channel selection module 20 or the interactive operation module 30 fetches the corresponding interactive message S5 from the interactive message database 23. That is, the corresponding interactive message S5 is found based on the program being watched. Another way to implement the equivalent function is the remote message broadcasting, which finds the audience who is watching the program based on the interactive message S5 corresponding to the program.

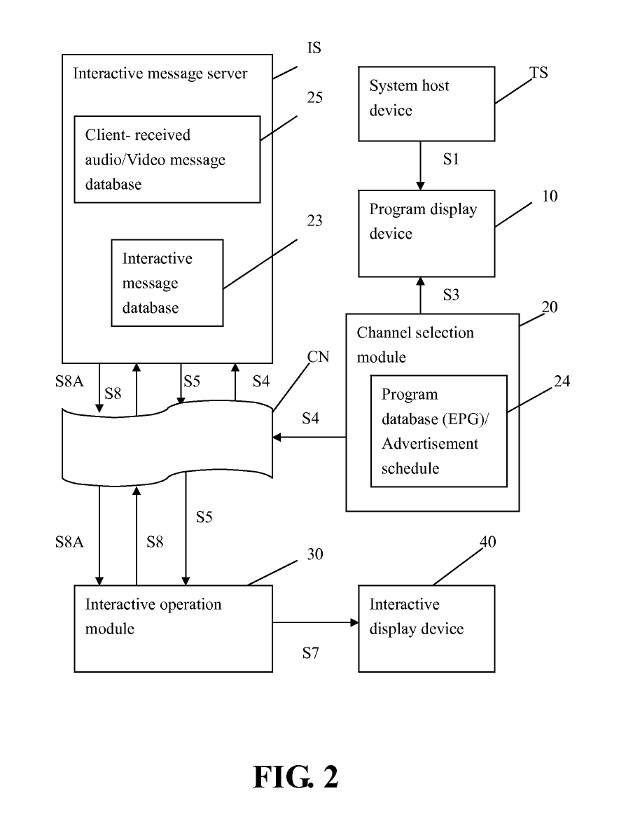

Refer to FIG. 2 illustrating the television interactive system according to the second embodiment of the present invention. Accordingly, the program display device 10 of the second embodiment receives the audio/video information Si from the host device TS of the system supplier, and the audio/video information S1 at least comprises the audio/video programs and the advertisement contents. At the same time, the program display device 10 displays the audio/video program and the advertisement content of the audio/video information S1. The channel selection module 20 has an operation interface of channel switch or program selection provided for the audience to switch the channel of the audio/video program or program on demand displayed by the program display device 10. That is, the audience switches the program channel or selects program on demand to generate the channel selection control message S3, which is received by the program display device 10 through the wire or wireless means. As a result, the corresponding audio/video program on the program display device 10 is controlled, and the ID information related to the audio/video program is integrated into the receive audio/video message S4 by the channel selection module 20, which is transmitted to the interactive message server IS in the remote side.

More specifically, the remote interactive message server IS comprises the interactive message database 23 storing a plurality of interactive messages S5, each corresponding to one receive audio/video message S4, and the client-received audio/video message database 25 including a plurality of client lists and the client receive information. The interactive message server IS receives the receive audio/video message S4 from the channel selection module 20 through the communication network CN, and fetches the interactive message S5 for interaction from the interactive message database 23. Then, the client lists and the client receive information are found from the client-received audio/video message database 25 by using the receive audio/video message S4, and the interactive message S5 is transmitted to the interactive operation modules 30 for all clients on the client lists through the communication network CN.

Accordingly, the interactive operation modules 30 can be employed to receive the interactive message S5, generates and transmits the corresponding display message S7 to the interactive display device 40, which shows the display message S7. At the same time, the interactive operation modules 30 possesses the interactive operation interface for providing the audience to perform the interactive operation based on the display message S7 shown by the interactive display device 40 so as to generate the interactive response message S8, which is transmitted to the interactive message server IS through the communication network CN, thereby implementing the interactive function.

Some illustrative examples are described as follows (the related data are the same as the above examples):

For the audience with the client code 101 selecting the program of the channel 12, the channel selection module 20 integrates the related ID data into the receive audio/video message S4, and the channel ID code corresponding to the receive audio/video message S4, TTV, is found from the channel ID code database. If the present time is 102/01/01 20:00, the program code, P01-102002, is fetched from the EPG 24. Then, the channel selection module 20 transmits the receive audio/video message S4 to the client-received audio/video message database 25 of the interactive message server IS through the communication network CN.

The following table shows part of the content of the client-received audio/video message database 25.

| Client | Channel | | Program/adver- |
|---|---|---|---|
| code | ID code | Show time | tisement code |
| 101 | TTV | 102/01/01 | P01-102002 |
| | | 20:00 | |
| 102 | CTS | 102/01/01 | A03-102005 |
| | | 20:00 | |
| 103 | TTV | 102/01/01 | P01-102002 |
| | | 20:00 | |

The program code P01-102002 corresponding to the interactive message S5 in the interactive message database 23, “please select the number of the candidate for the champion”, is used by the interactive message server IS to find the client codes through the client-received audio/video message database 25. As a result, the client codes are 101 and 103. Then, the interactive message server IS transmits the interactive message S5 to the interactive operation modules 30 for all the clients on the client list.

The interactive operation modules 30 configured for the audience with the client code 101 receives the interactive message S5 to generate the corresponding display message S7, “please select the number of the candidate for the champion”, which is transmitted to the interactive display device 40 to display such that the audience can start performing the interactive operation. The above examples are only illustrative.

For the interactive function, the interactive display module 40 shows the display message S7 according to the interactive message S5 after the audience uses the channel selection module 20 to complete the channel selection such that the audience can employs the interactive operation modules 30 to perform the interaction base on the display message S7. This is referred to passive push broadcasting means. However, the television interactive system of the present invention is not limited to the above mentioned. In other words, the audience can also first watch the display message S7 corresponding to the interactive message S5, and then uses the channel selection module 20 to switch the desired channel and select the audio/video program and advertisement related to the interactive message S5. This is called active push broadcasting means.

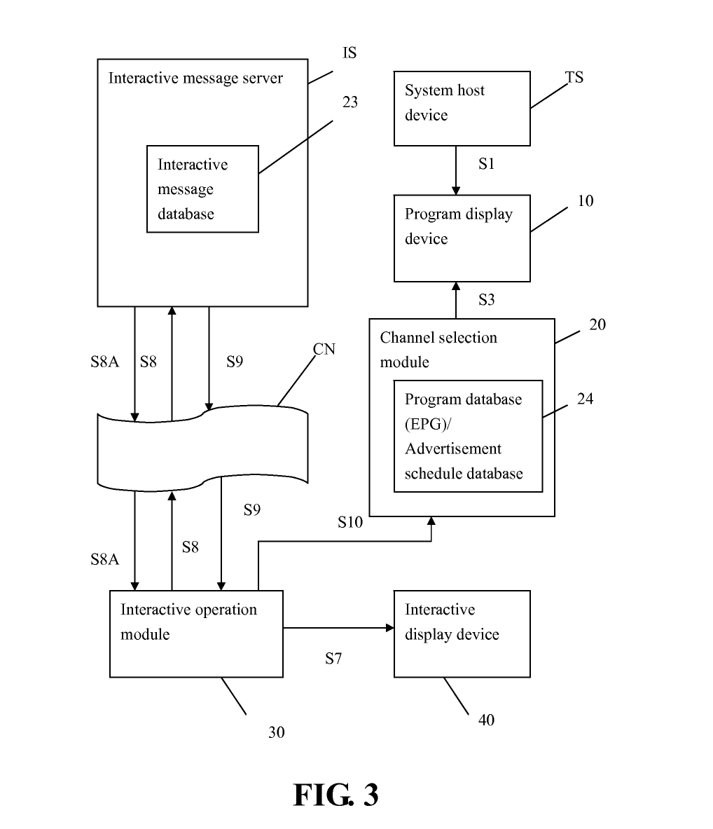

Refer to FIG. 3 illustrating the television interactive system according to the third embodiment of the present invention. First, the interactive message server IS transmits the interactive push broadcasting message S9 to the interactive operation modules 30 through the communication network CN. The interactive push broadcasting message S9 preferably comprises at least the interactive message S5 and the audio/video ID message S10 corresponding to the interactive message S5. The interactive operation modules 30 transmits the display message S7 based on the interactive message S5 to the interactive display device 40 to display the content such that the audience is allowed to perform the interactive operation. At the same time, the audio/video ID message S10 which specifically comprises the channel ID code and the show time of the audio/video program is transmitted to the channel selection module 20. Alternatively, the audio/video ID message S10 may comprise the program code or the advertisement code, which are used to find the corresponding channel ID code and show time from the EPG 24. In case of program on demand, the audio/video ID message S10 is directly the program code or the advertisement code. After being generated by the channel selection module 20, the channel selection control message S3 is further transmitted in the wire or wireless manner to the program display device 10 so as to control the program display device 10 to display the corresponding audio/video program.

Therefore, without the audience's operation, the above active push broadcasting means can implement the achievement that the interactive message server IS actively broadcasts the interactive push broadcasting message S9 to the interactive operation modules 30, the interactive display device 40 displays the display message S7, and at the same time, the channel or program on demand specified by the audio/video ID message S10 is switched by the channel selection module 20 such that the program display device 10 displays the audio/video program corresponding to the channel.

Furthermore, in order to prevent the audience from rejecting the above active push broadcasting means due to some sense of oppression, it is preferred that the interactive operation interface of the interactive operation modules 30 is provided with a mode switch key for the audience to determine whether the active push broadcasting means is invoked or not.

Below are some illustrative examples (the related data are the same as the above examples):

The interactive push broadcasting message S9 included in the active push broadcasting interactive advertisement “try out the moistening facial film” is transmitted to the interactive operation modules 30 by the interactive message server IS through the communication network CN. For example, the interactive message S5 included in the interactive push broadcasting message S9 is “welcome to request of the free sample of moistening facial film, and please leave mail address to deliver”, and the audio/video ID message S10 for the audio/video program corresponding to the interactive message includes the channel code CTV (China TV) and the show time 102/01/01 22:10. At the show time, the interactive operation modules 30 transmits the display message S7 based on the interactive message S5 “welcome to request of the free sample of moistening facial film, and please leave mail address to deliver” to the interactive display device 40 to display, and further provides the audience for interaction. This time, the audio/video ID message S10 is transmitted to the channel selection module 20, which may use the channel ID code CTV included in the audio/video ID message S10 to find the channel number CH14 from the channel ID code database. The channel selection module 20 generates the IR remote control signal as the channel selection control message S3 for selecting Ch14 so as to control the program display device 40 to switch to the 14th channel. Thus, the audience can start performing the interactive operation. The above examples are only illustrative.

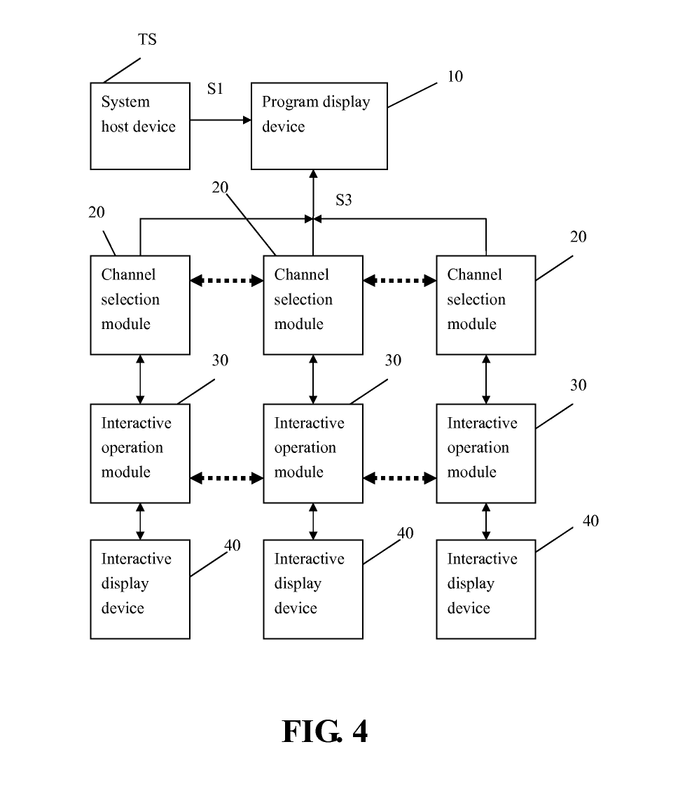

Please refer to FIG. 4 illustrating the television interactive system according to the fourth embodiment of the present invention. As shown in FIG. 4, the television interactive system of the fourth embodiment generally comprises the program display device 10, the channel selection modules 20, the interactive operation modules 30 and the interactive display devices 40. The technical characteristics of the channel selection modules 20, the interactive operation modules 30 and the interactive display devices 40 are similar to those in the previous embodiments, and the related detailed descriptions are thus omitted hereinafter.

It should be noted that the primary difference between the fourth embodiment and the first embodiment in FIG. 1 is that the channel selection modules 20 in the fourth embodiment are connected to the same program display device 10, and each interactive operation modules 30 is connected to the corresponding the channel selection module 20 and the corresponding interactive display device 40 such that the audience can use the interactive unit composed of the channel selection module 20, the interactive operation module 30 and the interactive display device 40 to respectively and independently perform the channel switch operation and the interactive operation. Especially, the integrity of the audio/video program or the content of the advertisement displayed by the program display device 10 is not influenced.

Moreover, another difference is that when any audience uses the channel selection module 20 to switch the channel of the audio/video program, this channel selection module 20 can synchronously transmit the current audio/video data (i.e. the receive program message S4), to the other channel selection modules 20 for the remaining audiences via the wire or wireless means like internet, IR, Bluetooth or Wifi. Alternatively, the interactive operation module 30 corresponding to this channel selection module 20 transmitting the receive program message S4 can synchronously transmit the generated interactive message S5 to the other interactive operation modules 30, as shown by the dashed lines in FIG. 4. Therefore, all the interactive operation module 30 can receive the same interactive message S5 simultaneously, and the respective interactive display devices 40 display the same display message S7 such that every audience can independently perform the interactive operation without causing any interference.

Additionally, the channel selection module 20 or the interactive operation modules 30 may further possess a GPS (global positioning system) function such that the response message may include the GPS information, and the interactive information related to the appropriate geography and location is added to the interactive message S5 or the interactive push broadcasting message S9 by the interactive message server IS based on the GPS information, such as the advertisements of the promotion event for new products or the yearly celebration event of the department store in the vicinity.

The present invention further comprises a good friend manage module (not shown) and the good friend manage module is preferably integrated with the interactive operation module 30 as a body such that when the audience performs the interactive operation, the interactive operation modules 30 transmits the data and the invitation message related to the interactive message S5 to at least one of the audience's good friends specified by the good friend manage module via the communication network. Therefore, all the audiences can invite at least one of good friends to participate in the interaction for the same program or advertisement based on the friendship.

Therefore, one of the primary aspects of the present invention is that the channel selection module is provided for the audience to select the desired channel program to show, and the interactive operation module is used to control the interactive display device to display the interactive message. At the same time, the audience can employ the interactive operation module to generate the response message, which is sent to the interactive message server for the interactive programs or advertisements, thereby implementing the bi-directional interactive function. In particular, the normal channel programs are displayed without any influence.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A television interactive system for providing an interactive function between programs and/or advertisements and at least one audience, comprising:
a program display device receiving an audio/video information from a host device of a system supplier, the audio/video information at least comprising audio/video programs and advertisement contents, wherein the program display device displays the audio/video programs and the advertisement contents;
at least one channel selection module, each having an operation interface of channel switch or program on demand provided for a corresponding audience to switch a channel of the audio/video program or program on demand displayed in the program display device so as to generate a channel selection control message, wherein the channel selection module transmits the channel selection control message to the program display device through a wire or wireless means to control the corresponding audio/video program displayed in the program display device, and at the same time, the channel selection module integrates an identification data associated with the audio/video program into a receive audio/video message, transmits the receive audio/video message, fetches an interactive message corresponding to the receive audio/video message from an interactive message database, and transmits the interactive message, the interactive message database storing a plurality of interactive messages, each corresponding to at least one receive audio/video message;
at least one interactive operation module, each connected to the corresponding channel selection module for receiving the interactive message to generate and transmit a corresponding display message, or alternatively receiving the receive audio/video message from the channel selection module to fetch the interactive message from the interactive message database so as to generate and transmit the corresponding display message based on the interactive message, the interactive operation module comprising an interactive operation interface provided for the corresponding audience; and
at least one interactive display device, each connected to the corresponding interactive operation module for receiving and displaying the display message from the interactive operation module, wherein the corresponding audience uses the interactive operation interface of the interactive operation module based on the display message displayed on the interactive display device to perform an interactive operation, the interactive operation module generates a response message transmitted to an interactive message server through a communication network implemented by a wire or wireless network, the interactive message server generates a further interactive message based on the response message, and transmits the further interactive message to the interactive operation module through the communication network, and the interactive display device displays the further interactive message for the corresponding audience, thereby implementing the interactive function.

2. The television interactive system as claimed in claim 1, wherein the host device comprises a system host device used to service cable TVs, wireless TVs or web TVs, and the program display device is a television set, a set top box, a monitor with an image display function, a computer monitor or a projector.

3. The television interactive system as claimed in claim 1, wherein the interactive message database is configured in a proximal or remote server, the channel selection module comprises an electronic program guide (EPG)/advertisement schedule database for storing a plurality of program codes and a plurality of advertisement codes, and the electronic program guide (EPG)/advertisement schedule database comprises the interactive message database.

4. The television interactive system as claimed in claim 1, wherein the receive audio/video message or the audio/video identification message comprises a channel identification code and a present time for the audio/video program, or a program code/advertisement code, the channel identification code is channel identification data corresponding to a channel number through the host device, and the program code/advertisement code corresponds to the channel identification code and the present time through the electronic program guide (EPG)/advertisement schedule database.

5. The television interactive system as claimed in claim 1, wherein the operation interface of channel switch or program on demand comprises a plurality of keys, each provided with a specific preset function, or the operation interface is a touch screen provided with a touch control function.

6. The television interactive system as claimed in claim 1, wherein the interactive operation interface comprises a plurality of keys, or the interactive operation interface is a touch screen provided with a touch control function.

7. The television interactive system as claimed in claim 1, wherein the interactive operation module and the interactive display device are combined together, or alternatively the channel selection module, the interactive operation module and the interactive display device are integrated as a body.

8. The television interactive system as claimed in claim 1, wherein the interactive operation module and the interactive display device are implemented by a smart phone or a tablet PC provided with APP (application) software.

9. The television interactive system as claimed in claim 1, wherein the channel selection module, the interactive operation module and the interactive display device are implemented by a smart phone or a tablet PC provided with APP software.

10. A television interactive system for providing an interactive function between programs and/or advertisements and at least one audience, comprising:
a program display device receiving an audio/video information from a host device of a system supplier, the audio/video information at least comprising audio/video programs and advertisement contents, wherein the program display device displays the audio/video programs and the advertisement contents;
at least one channel selection module, each having an operation interface of channel switch or program on demand provided for a corresponding audience to switch a channel of the audio/video program or the program on demand displayed in the program display device so as to generate a channel selection control message, wherein the channel selection module transmits the channel selection control message to the program display device by a wire or wireless means to control the corresponding audio/video program displayed in the program display device, and at the same time, the channel selection module integrates an identification data associated with the audio/video program into a receive audio/video message, and transmits the receive audio/video message through a communication network implemented by a wire or wireless network;
an interactive message server comprising an interactive message database and a client-received audio/video message database, wherein the interactive message database stores a plurality of interactive messages, each corresponding to one receive audio/video message, the client-received audio/video message database comprises a plurality of client lists and a plurality of client receive information for respective clients on the client lists, the interactive message server receives the receive audio/video message from the channel selection module through the communication network based on the client lists and the corresponding client receive information, fetches the interactive message corresponding to the interactive message for interaction from the interactive message database, and the receive audio/video message and finds the client list corresponding to the receive audio/video message from the client-received audio/video message database, and the interactive message server further transmits the interactive message to the interactive operation modules for all clients on the client list through the communication network;
at least one interactive operation module, each connected to the communication network for receiving the interactive message from the interactive message server to generate and transmit a corresponding display message, wherein the interactive operation module comprises an interactive operation interface provided for the corresponding audience; and
at least one interactive display device, each connected to the corresponding interactive operation module for receiving and displaying the display message from the interactive operation module, wherein the corresponding audience uses the interactive operation interface of the interactive operation module based on the display message displayed on the interactive display device to perform an interactive operation, the interactive operation module generates a response message transmitted to the interactive message server through the communication network, the interactive message server generates a further interactive message based on the response message, and transmits the further interactive message to the interactive operation module through the communication network, and the interactive display device displays the further interactive message for the corresponding audience, thereby implementing the interactive function.

11. The television interactive system as claimed in claim 2, wherein the host device comprises a system host device used to service cable TVs, wireless TVs or web TVs, and the program display device is a television set, a set top box, a monitor with an image display function, a computer monitor or a projector.

12. The television interactive system as claimed in claim 2, wherein the interactive message database is configured in a proximal or remote server, the channel selection module comprises an electronic program guide (EPG)/advertisement schedule database for storing a plurality of program codes and a plurality of advertisement codes, and the electronic program guide (EPG)/advertisement schedule database comprises the interactive message database.

13. The television interactive system as claimed in claim 2, wherein the receive audio/video message or the audio/video identification message comprises a channel identification code and a present time for the audio/video program, or a program code/advertisement code, the channel identification code is channel identification data corresponding to a channel number through the host device, and the program code/advertisement code corresponds to the channel identification code and the present time through the electronic program guide (EPG)/advertisement schedule database.

14. The television interactive system as claimed in claim 2, wherein the operation interface of channel switch or program on demand comprises a plurality of keys, each provided with a specific preset function, or the operation interface is a touch screen provided with a touch control function.

15. The television interactive system as claimed in claim 2, wherein the interactive operation interface comprises a plurality of keys, or the interactive operation interface is a touch screen provided with a touch control function.

16. The television interactive system as claimed in claim 2, wherein the interactive operation module and the interactive display device are combined together, or alternatively the channel selection module, the interactive operation module and the interactive display device are integrated as a body.

17. The television interactive system as claimed in claim 2, wherein the interactive operation module and the interactive display device are implemented by a smart phone or a tablet PC provided with APP (application) software.

18. The television interactive system as claimed in claim 2, wherein the channel selection module, the interactive operation module and the interactive display device are implemented by a smart phone or a tablet PC provided with APP software.

19. A television interactive system for providing an active push broadcasting function and an interactive function between programs and/or advertisements and at least one audience, comprising:
a program display device receiving an audio/video information from a host device of a system supplier, the audio/video information at least comprising audio/video programs and advertisement contents, wherein the program display device displays the audio/video programs and the advertisement contents;
at least one channel selection module, each having an operation interface of channel switch or program on demand provided for a corresponding audience to switch a channel of the audio/video program or the program on demand displayed in the program display device;
an interactive message server comprising an interactive message database, which stores at least one interactive push broadcasting message transmitted through a communication network implemented by a wire or wireless network, wherein the interactive push broadcasting message at least comprises an interactive message and an audio/video identification message for an audio/video program corresponding to the interactive message;
at least one interactive operation module, each connected to the communication network for receiving the interactive push broadcasting message from the interactive message server, wherein the interactive operation module generates and transmits a corresponding display message based on the interactive message included in the interactive push broadcasting message, and further transmits the audio/video identification message included in the interactive push broadcasting message to the channel selection module, the channel selection module generates a channel selection control message according to the audio/video identification message, and transmits the channel selection control message to the program display device through a wire or wireless means so as to control the corresponding audio/video program displayed by the program display device, and the interactive operation module has an interactive operation interface providing for the audience; and
at least one interactive display device, each connected to the corresponding interactive operation module for receiving and displaying the display message from the interactive operation module, wherein the corresponding audience uses the interactive operation interface of the interactive operation module based on the display message displayed on the interactive display device to perform an interactive operation, the interactive operation module generates a response message transmitted to the interactive message server through the communication network, the interactive message server generates a further interactive message based on the response message, and transmits the further interactive message to the interactive operation module through the communication network, and the interactive display device displays the further interactive message for the corresponding audience, thereby implementing the interactive function.

20. The television interactive system as claimed in claim 3, wherein the host device comprises a system host device used to service cable TVs, wireless TVs or web TVs, and the program display device is a television set, a set top box, a monitor with an image display function, a computer monitor or a projector.

21. The television interactive system as claimed in claim 3, wherein the interactive message database is configured in a proximal or remote server, the channel selection module comprises an electronic program guide (EPG)/advertisement schedule database for storing a plurality of program codes and a plurality of advertisement codes, and the electronic program guide (EPG)/advertisement schedule database comprises the interactive message database.

22. The television interactive system as claimed in claim 3, wherein the receive audio/video message or the audio/video identification message comprises a channel identification code and a present time for the audio/video program, or a program code/advertisement code, the channel identification code is channel identification data corresponding to a channel number through the host device, and the program code/advertisement code corresponds to the channel identification code and the present time through the electronic program guide (EPG)/advertisement schedule database.

23. The television interactive system as claimed in claim 3, wherein the operation interface of channel switch or program on demand comprises a plurality of keys, each provided with a specific preset function, or the operation interface is a touch screen provided with a touch control function.

24. The television interactive system as claimed in claim 3, wherein the interactive operation interface comprises a plurality of keys, or the interactive operation interface is a touch screen provided with a touch control function.

25. The television interactive system as claimed in claim 3, wherein the interactive operation module and the interactive display device are combined together, or alternatively the channel selection module, the interactive operation module and the interactive display device are integrated as a body.

26. The television interactive system as claimed in claim 3, wherein the interactive operation module and the interactive display device are implemented by a smart phone or a tablet PC provided with APP (application) software.

27. The television interactive system as claimed in claim 3, wherein the channel selection module, the interactive operation module and the interactive display device are implemented by a smart phone or a tablet PC provided with APP software.
